(19) United States
(12) Patent Application Publication
(10) Pub. No.: US 2002/0127292 A1
(43) Pub. Date: Sep. 12, 2002

(54) REMOVABLE HOLLOW PLUG FOR AIR VENT IN A MOLD

(76) Inventors: Giancarlo Gallinotti, Panderno Dugnano (IT); Mario Secchi, Milano (IT)

Correspondence Address: FINNEGAN, HENDERSON, FARABOW, GARRETT &, DUNNER LLP, 1300 I STREET, NW, WASHINGTON, DC, 20005, US

(21) Appl. No.: 09/836,349

(22) Filed: Apr. 18, 2001

Related U.S. Application Data
(63) Continuation of application No. PCT/EP99/07939, filed on Oct. 19, 1999.
(60) Provisional application No. 60/105,534, filed on Oct. 22, 1998.

(30) Foreign Application Priority Data
Oct. 19, 1998 (EP) 98119679.3

(51) Int. Cl. B29C 33/46

(52) U.S. Cl. 425/28.1; 249/141; 29/564

(57) ABSTRACT

A removable plug for an air vent in a mold includes an annular bushing and an annular insert. The annular bushing includes a central bore preferably of about 0.8 mm. The annular insert includes a central bore preferably of about 0.1 mm to 0.4 mm. The annular insert is snugly fitted into the central bore of the annular bushing. A mold including the plug and a method for making the mold are also described.

The present invention generally relates to the construction of molds used for the formation of items from compound materials such as rubber. More specifically, the present invention concerns the construction of the vent holes that permit air to escape from the mold as the compound material fills the mold and begins to solidify. Most specifically, the present invention concerns the construction of removable, hollow plugs that can be inserted into the vent holes in a mold for making pneumatic tires to permit air to exit the mold during the period when the tire is molded and vulcanized.

As is known to those skilled in the art, the manufacture of pneumatic tires primarily involves two phases. The first phase involves the assembly of the different parts of a tire together, such as the belted plies, the tread band, and the carcass. Once assembled, the tire is referred to generally as a “green” tire until it is cured or vulcanized. The vulcanizing process is the second significant phase of the tire manufacturing process. During the vulcanizing phase, the green tire is placed inside of a mold, the tread pattern and brand-specific ornamentation (e.g., brand name, size, and tire inflation information) are impressed upon the tire's surface, and the tire is heated for a predetermined time until the polymers cross-link sufficiently so that the tire may be used in a suitable application.

Molds for vulcanizing tires can take any number of different forms, depending upon the type of tire produced. Regardless of the type of mold employed, however, the present invention is equally applicable.

The simple, conventional tire mold known to those in the art consists of two halves or dies that are brought together around the green tire before the tire is vulcanized. The two halves of the mold impress upon the green tire both the tread pattern and also whatever surface ornamentation is to be included on the surface of the sidewalls of the tire.

More complex molds, such as centripetal molds, are also known to those skilled in the art. In a centripetal mold, essentially three parts are brought together to form the tire. The first two parts are the two side wall-forming structures known as the “cheeks,” which establish the contour of the sidewalls of the tire and generate whatever lettering, ornamentation, or other indicia is to be included on the sidewall's surface. The tread, on the other hand, is impressed upon the tire by the third part of the mold, which is made up of a number of separate segments or sectors that are positioned adjacent one to each others between the sidewall cheeks.

While the centripetal mold is the focus of the discussion that follows, those skilled in the art will recognize that the type of mold is not relevant to the invention described and claimed, but that the invention may be applied to any mold used for the manufacture of tires. Moreover, those skilled in the art will readily appreciate that the present invention is equally applicable to molds for the formation of objects from any sufficiently viscous material and not just objects made from compound materials such as rubber.

At the end of the manufacture, the green tire is positioned in the mold and then, a curing bladder is inserted. The curing bladder is hence inflated with a heated fluid such as water, steam, or gas under high pressure, so as to help squeeze the surface of the green tire into and against the surface of the mold so that it accepts all of the details from the mold.

During this manufacturing phase, air bubbles often are trapped mechanically between the green tire and the interior surface of the mold. If the air bubbles are not permitted to escape, they create notches or pits in the surface of the tire as it cures. Not only can surface imperfections affect the salability of a tire, because consumers are accustomed to purchasing products with a smooth surface configuration free of such defects, but they can also seriously effect the operability of the tire. When bubbles form at the surface of the tire during the vulcanizing phase, the compound material does not cure evenly. Instead, the material hardens with an even density throughout the circumference of the tire. While these areas of uneven density cannot be seen with the naked eye, they can seriously affect a tire's performance by throwing off the balance of the tire, especially at higher speeds.

In both the conventional mold and the centripetal mold, air bubbles are permitted to escape from the mold through venting holes that have been drilled through the various elements of the mold.

In the conventional mold, several hundred to several thousand holes are needed. The same is also true for the centripetal mold; and, moreover, because the design differs, the placement of the holes also differs from mold to mold. In the centripetal mold, the cheeks each include between 300 to 800 venting holes to permit air to escape. The various tread-forming sectors also include venting holes. In addition, air is permitted to escape through small openings between the tread-forming sectors, which are designed so that, when they meet one another around the periphery of the green tire, there is a very small tolerance engineered between them that permits the exit of some of the trapped air. The small tolerance is on the order of 0.1 millimeters (mm).

Wherever the venting holes are drilled, either through the tread forming region or the cheeks, the location of the holes depends upon the type of the tread band of the tire produced and the amount and type of surface ornamentation added to the tire. More holes are needed where air tends to concentrate the most usually around the tread pattern and lettering that are incorporated into the tire design.

Traditionally, venting holes have been drilled through the cheeks and tread-forming region with a screw-type drill bit with as small a-diameter as possible. However, there is a limit to how small a drill bit can be made in a stainless steel mold, because the bit will break during drilling if it is too narrow. As a result, the diameter of a traditional venting hole usually is not smaller than about 0.6 mm.

Before rubber begins to solidify during vulcanizing phase, for his viscosity and for the pressure which is submitted, it will readily flow into a hole with a diameter of 0.6 mm or more.

When rubber flows into the venting holes, two problems are created. First, if the rubber comes out of the venting holes when the tire is removed from the mold, the tire will have on its surface a number of rubber, hair-like protrusions or follicles that preferably must be removed before the tire is sold. Removal of the protrusions is often a manual task that requires considerable time and expense. Even if automated, the removal of the protrusions adds to the cost of a tire because it adds another operation (and another piece of expensive equipment) to the tire manufacturing process. Second, if the rubber remains in some of the venting holes when the tire is removed from the mold, those venting holes become blocked and air cannot escape when the next tire is placed into the mold. In particular if, for example, a bush with a small hole (0.6 to 1 mm) is inserted in bigger hole in the mold, it is possible that the rubber will flow into all the length of the bush until its end and will fill the enlarged space present at this point, forming a mass of rubber. This mass of rubber will be a stopper, and in the phase of removing the vulcanized tire such stopper will block the rubber in the bush. As tire after tire is vulcanized in the same mold, more and more of the venting holes become clogged until the mold must be removed from service so that the vents can be cleared. Usually, this occurs after about 500 to 600 tires are produced. Not only is it difficult and costly to clear the venting holes, but, after repeated vulcanizing cycles, rubber left in the venting holes becomes inelastic because the polymers in the rubber become heavily cross-linked. This further complicates and increases the cost of the clearing operation.

In the past, several solutions to this problem have been suggested. One such solution is described in U.S. Pat. No. 4,436,497 (“the '497 patent”). There, a plug made of a sintered material is inserted into the conventional venting hole drilled through the mold. According to the '497 patent, and as required by venting holes generally, the bore through the center of the vent plug is smaller than the bore of the venting hole. This permits air to escape from the mold while reducing the amount of rubber that enters the bore. While the '497 patent does not eliminate the creation of the rubber follicles, it provides a chamfered inlet to the bore to increase the attachment strength of the follicle to the tire and, therefore, increases the probability that the rubber follicle will remain attached to the tire when the tire is removed from the mold. Since the chamfered region increases the probability that the rubber follicle will stick to the tire, it also, reduces the probability that the vent plugs will become clogged through repeated use. The '497 patent, then, addresses only one of the two problems inherent in the manufacture of a tire.

Plugs made from sintered or metal materials are not the only plugs suggested by the prior art. For example, U.S. Pat. No. 4,447,197 (“the '197 patent”) describes the use of plastic plugs with a low affinity for or adherence to rubber. As described by the '197 patent, plugs constructed from the plastic material described are-more likely than metal plugs to release the rubber from the inner bore. This minimizes the likelihood that the venting plugs will become clogged with rubber during use. The plastic plugs described in the '197 patent are cylindrically-shaped and are press-fitted into the openings of the venting holes that are drilled through the mold. The '197 patent, just like the '497 patent, eliminates only one of the problems inherent in the manufacture of tires.

Other solutions to the same problem addressed by the present invention have also been suggested, such as the hollow plug of U.S. Pat. No. 4,662,833 (“the '833 patent”). The '833 patent describes a plug with a reduced bore section 21 having a diameter of 0.010 to 0.015 inches-and a shoulder with an axial length between 0.010 and 0.015 inches. The axial length of the shoulder provides the plug with a dull knife edge to facilitate severing of whatever rubber material is extruded into the main bore section 24 of cylindrical body member 18. According to the disclosure of the '833 patent, the plug permits rubber to expand into main bore section 24. The rubber that expands into this section is severed by removing the tire from the mold, leaving a protrusion on the tire surface that is relatively minute and is on the order of being paper thin. However the '883 patent increases the probability that said section will become clogged by the rubber removed from the tire.

Still other solutions to the problems inherent in molding tires have been put forth. For example, in U.S. Pat. No. 3,377,662 (“the '662 patent”), a number of variations on a vent plug are described. In the '662 patent, the vent plug may include a core member 6 with a plurality of small grooves 7 with a small depth of between 0.1 and 0.2 mm provided on its exterior. Alternatively, a core member 11 may be provided with fine grooves also with a depth of 0.1 mm on its outside diameter. In a third example, the plug may include a bundle 10 of fine wires. While the patent does not indicate if the rubber follicles are eliminated altogether, the different embodiments described are particularly complex, requiring a detailed manufacturing processes to make.

Other solutions offered by the prior art include the filter-type plug of U.S. Pat. No. 3,804,566, or the washer and wire combination taught by U.S. Pat. No. 4,021,168. Each of these examples offers a slightly different approach to the same problem.

None of the prior art examples, however, offer a simple design for venting holes that both eliminates the production of rubber follicles on the tire and prevents the venting holes from becoming clogged. The present invention offers solutions to both of these problems.

In developing the present invention, it was realized that, if the venting holes in a mold could be made small enough, air could escape but the compound material would be too viscous to flow into the venting holes. In particular, it was realized that, even if some rubber could flow into a small hole, the diameter should be small enough in order that the rubber does not flow until the end of the small hole and it remains within the venting hole. It was also realized that, if there are not variation of the internal diameter of the venting holes, the possible rubber that could be flow inside, when the vulcanized tire is removed outside the mold, it is easily removed together.

As a result, it was believed that a mold could be designed that would not need to be removed frequently from service but that could produce an item, such as a tire, with a smooth, unblemished exterior and without variations in the density of the compound material making up the tire.

The applicant has been found that, it is possible to drill a relatively large hole in the mold and inserting in such hole a bush within an annular insert. Said annular insert has been realized with a technology that permits to obtain a hole with a diameter smaller than the current diameter of the mold's venting holes.

Accordingly the present invention provides a removable plug for an air vent in a mold having an annular bushing with a central bore of about 0.8 mm and an annular insert with a central bore of about 0.1-0.4 mm, preferably about 0.3 mm, snugly fitted into the central bore of the annular bushing. The annular bushing is preferably between 5 to 20 mm long and made of an aluminum alloy such as Aluminum 115. The insert is preferably no more than about 0.5 mm shorter than the bushing and made from a stainless steel alloy such as Stainless Steel 304. A portion of the exterior surface of the annular bushing may include a roughened portion to improve the grippability of the plug in the air vent. Moreover, the edges of the annular bushing may be shaped so as not to present a sharp geometry.

The present invention also provides for a mold for forming tires having a plurality of air vent channels between about 2 to 3 mm in diameter. A removable air vent plug is snugly fitted in each air vent channel to reduce its diameter by providing an annular bushing with an external diameter of about 2 to 3 mm and a central bore of about 0.8 mm. The annular bushing further includes an annular insert with a central bore of about 0.1-0.4 mm, preferably about 0.3 mm, snugly fitted into the central bore of the annular bushing. The annular bushing is preferably between 5 to 20 mm long and made of an aluminum alloy such as Aluminum 115. The insert is preferably no more than about 0.5 mm shorter than the bushing and made from a stainless steel alloy, such as Stainless Steel 304. A portion of the exterior surface of the annular bushing may include a roughened portion to improve the grippability of the plug. Moreover, the edges of the annular bushing may be shaped so as not to present a sharp geometry.

The present invention also provides for a method for making a tire mold by drilling a plurality of air vent channels through the tire mold, each air vent channel being between about 2 to 3 mm in diameter; and reducing the diameter of said air vent channels by snugly fitting a bushing into each air vent channel, the bushing having an annular insert therein that further reduces the diameter of the air vent channel to about 0.1-0.4 mm.

Finally, the present invention contemplates that the insert for the removable, hollow plug may be made from a surgical needle with the appropriate dimensions. Accordingly, the removable, hollow plug of the present invention can be manufactured easily and inexpensively.

The accompanying drawings, which are incorporated in and constitute part of the specification, illustrate several embodiments of the present invention. Together with the general description given above and the detailed description of the embodiments given below, the drawings serve to explain the principles of the present invention.

In the drawings:

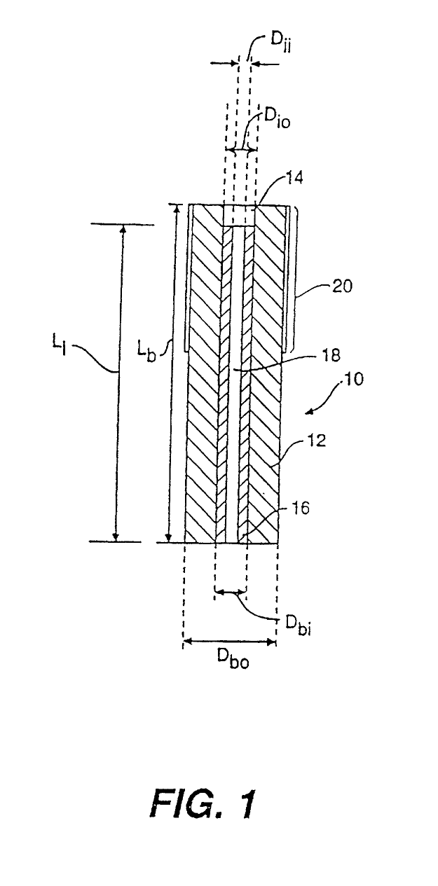

FIG. 1 illustrates a removable vent plug according to present invention;

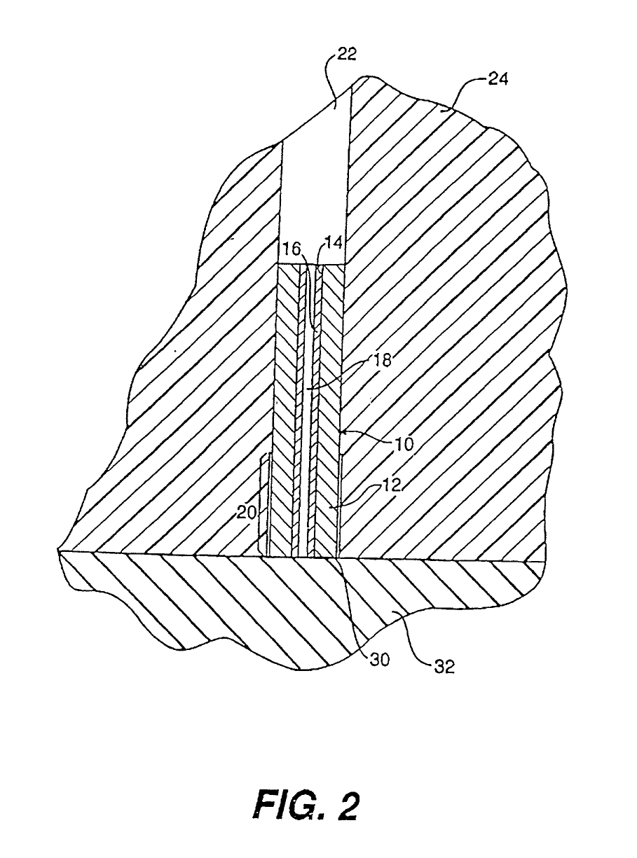

FIG. 2 depicts a portion of a mold according to the present invention, illustrating how a removable vent plug appears when inserted into a venting hole drilled through the mold;

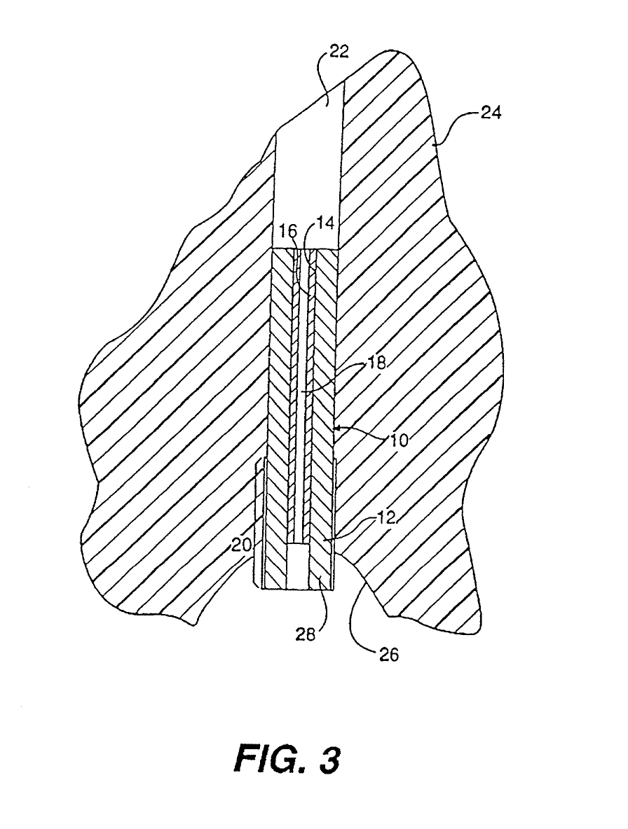

FIG. 3 shows a portion of a mold according to the present invention, showing the inserted position of a removable vent plug in a curved region of the mold, which has been exaggerated for purposes of discussion; and

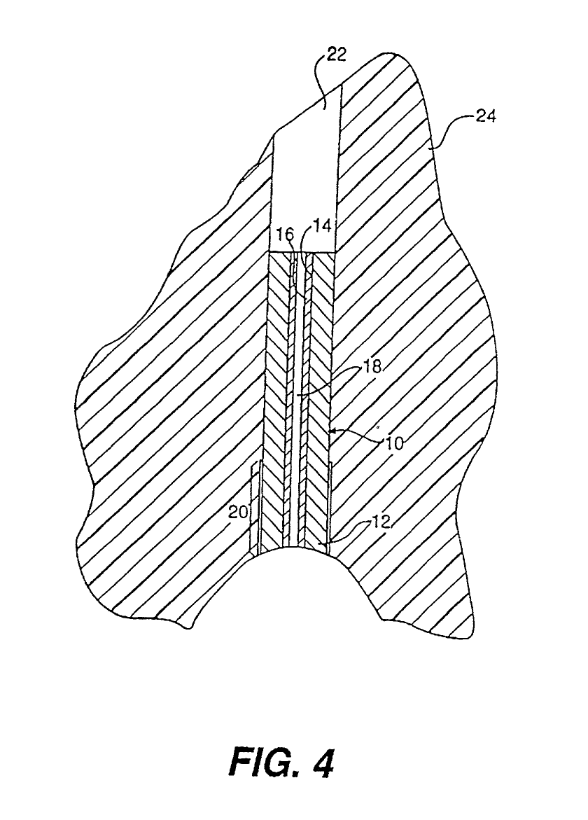

FIG. 4 illustrates the portion of the mold shown in FIG. 3 with a portion of the removable vent plug having been mechanically carved away so that the interior surface of the mold is continuous and smooth.

Additional advantages and modifications of the present invention will readily occur to those skilled in the art. Therefore, the invention in its broader aspects is not limited to the specific details, representative devices, and illustrative examples shown and described. Accordingly, departures may be made from such details without departing from the spirit or scope of the general inventive concept as defined by the appended claims and their equivalents.

Referring to FIG. 1, removable vent plug 10 according to the present invention primarily comprises a bushing 12, which is preferably cylindrically-shaped with an outside diameter D_{bo} of between about 2 to 3 mm. While the present invention contemplates that outside diameter D_{bo} of bushing 12 is between about 2 to 3 mm, those skilled in the art will recognize that the outside diameter of bushing 12 may be of any suitable dimension to permit bushings 12 to be press-fitted into the vent holes of the particular mold for which they are designed. Moreover, as would be understood by those skilled in the art, outside diameter D_{bo} of bushing 12 need not be the same for each and every vent hole of the mold but, in fact, may vary if the particular mold includes vent holes of varying sizes.

It is preferred that length L_{b} of bushing 12 be between about 5 to 20 mm, more preferably 8 to 12 mm, depending upon the requirements of the particular mold and the economies involved in manufacturing bushing 12. Bushing 12 should not be so long that it protrudes from the exterior surface of the mold. By the same token, while bushing 12 may be longer than 20 mm, the longer the bushing, the higher the cost of manufacture. As a result, there is a point where cost will constrain the length of bushing 12.

It is preferred that bushing 12 of the present invention have a central cylindrical bore 14 with a diameter D_{bI} of about 0.8 mm, which is an acceptable minimum diameter for creating central bore 14 in bushing 12. For the preferred embodiment of the present invention, bushing 12 is aluminum. More preferably, bushing 12 is made of Aluminum 115, which is a specific type of aluminum, as would be understood by those skilled in the art.

While bushing 12 may be constructed from any suitable material, aluminum is preferred because: (1) aluminum is a relatively inexpensive material, (2) aluminum is easy to machine, and (3) the thermal expansion qualities of aluminum, which cause the aluminum to expand to a greater extent than the mold when heated, are well suited to this particular application. With respect to the third property listed, aluminum, and other materials with greater expansion properties than the mold material, are preferred because they become more firmly held in place as they expand when heated. Whatever material is chosen, however, it should withstand temperatures of up to 180° C., being the temperature at which tires are vulcanized between 140° and 160°.

In the preferred embodiment of the present invention, as illustrated in FIG. 1, insert 16 fits snugly within central bore 14 of bushing 12. As a result, insert 16 is cylindrically shaped with a preferred outside diameter D_{Io} of 0.8 mm or just slightly larger so that it can fit snugly into cylindrical bore 14. Insert 16 is hollow and is preferably provided with a central bore 18 having a diameter D_{II} of between about 0.1-0.4 mm, with the most preferred diameter being about 0.3 mm. LengthL, of insert 16 is preferably no more than 0.5 mm shorter than length L_{b} of bushing 14. Accordingly, length L_{I} of insert 16 is between about 4.5 to 19.5 mm and preferably between 7.5 and 11.5 mm. As with length L_{b} of bushing 12, length Lᵢ of insert 16 may vary, as would be understood by those skilled in the art, depending upon the particular application and the manufacturing economics involved. Insert 16 is preferably made from stainless steel, such as Stainless Steel 304, which is a particular type of stainless steel, as would be understood by those skilled in the art. Of course, insert 16 may be constructed from any alternative suitable material.

Length Lᵢ of insert 16 is purposefully shorter than length L_{b} of bushing 12 to accommodate, among other things, the different curves on the interior surface of the mold. FIGS. 3 and 4 help to explain this principle. As illustrated in exaggerated form in FIG. 3, all molds 24 contain regions where interior surface 26 of mold 24 is shaped or curved, requiring that bushing 12 be shaped so that there are no sharp transitions between interior surface 26 of mold 24 and the end surface of bushing 12. Accordingly, vent plug 10 of the present invention is constructed so that the portion of bushing 12 longer than insert 16 will protrude into the interior cavity of mold 24 when vent plug 10 is inserted into venting hole 22. Protruding portion 28 can then be shaped or carved away to leave a continuous surface on the interior of mold 24, as shown in FIG. 4. Moreover, even if bushing 12 is positioned where interior surface 26 of mold 24 is essentially flat, bushing 12 can be inserted so that a portion protrudes into mold 24. Protruding portion 28 can then be removed or carved away so that interior surface 26 of mold 24 is continuous and smooth.

It has to be noted that only the bushing 12 has to be removed, the insert 16 in stainless steel is in a back position because its length is shorter than the length of the bushing.

In an alternate embodiment of the present invention, which is also shown in both FIGS. 1 and 2, bushing 12 may include roughened portion 20 on its exterior surface to improve the snug fit of bushing 12 in hole 22 drilled through mold 24. In both figures, roughened portion 20 is shown with a thickness to emphasize and illustrate that roughened surface 20 has a greater grippability than the remainder of the surface of bushing 12. However, as would be clear to those skilled in the art, if roughened portion 20 does in fact have a slightly larger diameter than bushing 12, the increase in the diameter is only very slight.

To improve the frictional engagement between vent plug 10 and hole 22, bushing 12 may be manufactured so that it has a slightly larger diameter D_{bo} than the diameter of hole 22 at ambient temperature. When heated, mold 24 will expand so that bushing 12, at ambient temperature, may be inserted into hole 22. When mold 24 cools and contracts around vent plug 10, a snug fits forms between plug 10 and mold 24 because of the discrepancy between the outside diameterD_{bo} of bushing 12 and the diameter of hole 22.

FIG. 2 illustrates bushing 12 of the present invention inserted in venting hole 22 disposed through mold 24. As is also illustrated in the same figure, plug 10, once machined, is flush with the surface of mold 24 to prevent the creation of blemishes on the surface of tire 32. Moreover, as would occur during the vulcanizing phase for the manufacture of tire 32, tire 32 is flush with the interior surface of mold 24 and in contact with one end of bushing 12. Finally, in the construction of removable vent plug 10 of the present invention, it is preferred that edges 30 of bushing 12 be rounded so that sharp edges are avoided.

The dimensions of insert 16 are particularly important to the design of the present invention because a diameter D_{II} of about 0.3 mm is sufficiently small that rubber from tire 26 cannot enter bore 18 during the vulcanizing process. The rubber is simply so viscous that it cannot flow into so small an opening.

In some cases, according to the particularly viscosity of the rubber, it is possible that some rubber could flow into the insert 16. In such cases the length of the insert should be determined in a way that the flowing rubber cannot reach the output of the insert 16. That, should be done in order to not permit the creation of stopper at the end of the insert 16.

Moreover, the dimensions of insert 16 are similar to the dimensions of a standard surgical needle. As a result, plug 10 may be constructed by press fitting a surgical needle into bushing 12 to provide central bore 18 with a diameter of no more than 0.4 mm, with the preferred bore diameter being between about 0.2 and 0.3 mm, as indicated previously. This permits a quick, easy, and inexpensive construction for plug 10.

Finally, vent plug 10 is designed so that it can be easily removed from mold 24 and replaced, should it be necessary. With an appropriate tool, for example a long metallic rod, it is possible to tap out vent plug 10 from hole 22 so that vent plug 10 can be replaced.

Additional advantages and modification will readily occur to those skilled in the art. Therefore, the invention in its broader aspects is not limited to the specific details, representative devices, and illustrative examples shown and described. Accordingly, departures may be made from such details without departing from the spirit or scope of the general inventive concept as defined by the appended claims and their equivalents.

1. A mold for forming tires, comprising:
a plurality of air vent channels disposed through the mold, each air vent channel being between about 2 to 3 mm in diameter;
a removable air vent plug snugly fitted in each air vent channel to reduce the diameter of the air vent channel, each air vent plug comprising
an annular bushing having an external diameter of less than about 3 mm and a central bore of about 0.8 mm, and
an annular insert snugly fitted into the central bore of the annular bushing, the annular insert having a central bore of about 0.1-0.4 mm.

2. The mold of claim 1, wherein the central bore of the annular insert is about 0.3 mm.

3. The mold of claim 1, wherein the annular bushing comprises aluminum.

4. The mold of claim 3, wherein the annular bushing comprises Aluminum 115.

5. The mold of claim 1, wherein the annular insert comprises stainless steel.

6. The mold of claim 5, wherein the annular insert comprises Stainless Steel 304.

7. The mold of claim 1, wherein the annular bushing has a length between about 5 to 20 mm.

8. The mold of claim 7, wherein the annular bushing has a length between about 8 to 12 mm.

9. The mold of claim 7, wherein the annular insert has a length no more than about 0.5 mm less than the length of the annular bushing.

10. The mold of claim 1, wherein:
the annular bushing has an exterior surface, and
a portion of the exterior surface is roughened to improve frictional engagement between the removable plug and the air vent channel in which the removable plug is fitted.

11. The mold of claim 10, wherein edges of the annular bushing are shaped so as not to present a sharp geometry.

12. A method for making a tire mold, comprising the steps of:
drilling a plurality of air vent channels through the tire mold; and
reducing the diameter of said air vent channels by snugly fitting a bushing into each air vent channel, the bushing having an annular insert therein that further reduces the diameter of the air vent channel to about 0.1-0.4 mm.

13. The method of claim 12, wherein the annular bushing reduces the diameter of the air vent channel to about 0.3 mm.

14. The method of claim 12, further comprising the step of:
roughening a portion the bushing's exterior surface to improve frictional engagement between the bushing and the air vent channel in which the bushing is fitted.

15. The method of claim 12, further comprising the step of:
smoothing the bushing's edges so that the edges do not present a sharp geometry.

16. The method of claim 12, wherein the annular insert is a surgical needle that is inserted into the annular bushing.

17. The method of claim 12, further comprising the step of:
carving away a portion of the bushing extending into the interior of the mold so that the bushing is flush with the interior surface of the mold.

18. A removable plug for an air vent in a mold, comprising:
an annular bushing having a central bore of about 0.8 mm; and
an annular insert snugly fitted into the central bore of the annular bushing, the annular insert having a central bore of about 0.1-0.4 mm.

19. The removable plug of claim 18, wherein the central bore of the annular insert is about 0.3 mm.

20. The removable plug of claim 18, wherein the annular bushing comprises aluminum.

21. The removable plug of claim 20, wherein the annular bushing comprises Aluminum 115.

22. The removable plug of claim 18, wherein the annular insert comprises stainless steel.

23. The removable plug of claim 22, wherein the annular insert comprises Stainless Steel 304.

24. The removable plug of claim 18, wherein the annular bushing has a length between about 5 to 20 mm.

25. The removable plug of claim 24, wherein the annular bushing has a length of about 8 to 12 mm.

26. The removable plug of claim 25, wherein the annular insert has a length of no more than about 0.5 mm less than the length of the annular bushing.

27. The removable plug of claim 18, wherein:
the annular bushing has an exterior surface, and
a portion of the exterior surface is roughened.

28. The removable plug of claim 27, wherein edges of the annular bushing are shaped so as not to present a sharp geometry.
